(19) United States
(12) Patent Application Publication
(10) Pub. No.: US 2017/0049274 A1
(43) Pub. Date: Feb. 23, 2017

(54) Cooking Assembly

(71) Applicant: Terri Lynn Minor, Fayetteville, NC (US)

(72) Inventor: Terri Lynn Minor, Fayetteville, NC (US)

(21) Appl. No.: 14/829,878

(22) Filed: Aug. 19, 2015

(51) Int. Cl. A47J 44/00; A47J 36/06; A47J 27/00

(52) U.S. Cl. CPC A47J 44/00; A47J 27/004; A47J 36/06

(57) ABSTRACT

A cooking assembly for automatically browning meat includes a housing that has a lid and a pan. The pan may have meat positioned therein and the lid is positioned to cover the pan. A cooking unit is removably positioned within the pan and the cooking unit cooks the meat. A chopping unit is coupled to the lid and the chopping unit chops the meat in the pan.

### BACKGROUND OF THE DISCLOSURE

### Field of the Disclosure

The disclosure relates to cooking devices and more particularly pertains to a new cooking device for automatically browning meat.

### SUMMARY OF THE DISCLOSURE

An embodiment of the disclosure meets the needs presented above by generally comprising a housing that has a lid and a pan. The pan may have meat positioned therein and the lid is positioned to cover the pan. A cooking unit is removably positioned within the pan and the cooking unit cooks the meat. A chopping unit is coupled to the lid and the chopping unit chops the meat in the pan.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a cooking assembly according to an embodiment of the disclosure.

FIG. 2 is a perspective exploded view of an embodiment of the disclosure.

FIG. 3 is a front view of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 4 of an embodiment of the disclosure.

### DESCRIPTION OF THE PREFERRED EMBODIMENT

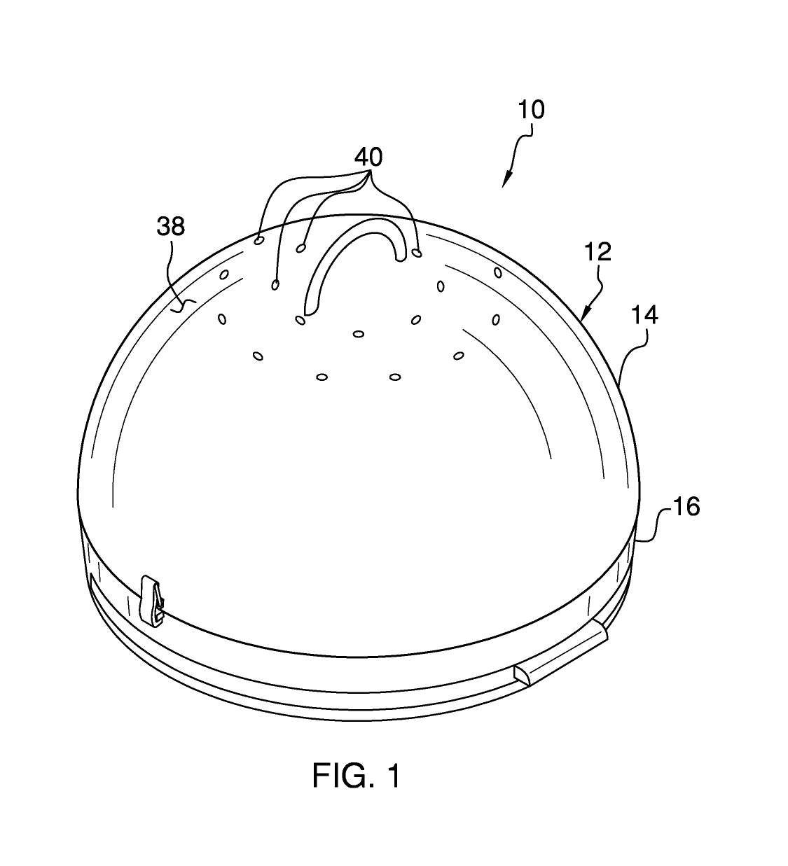

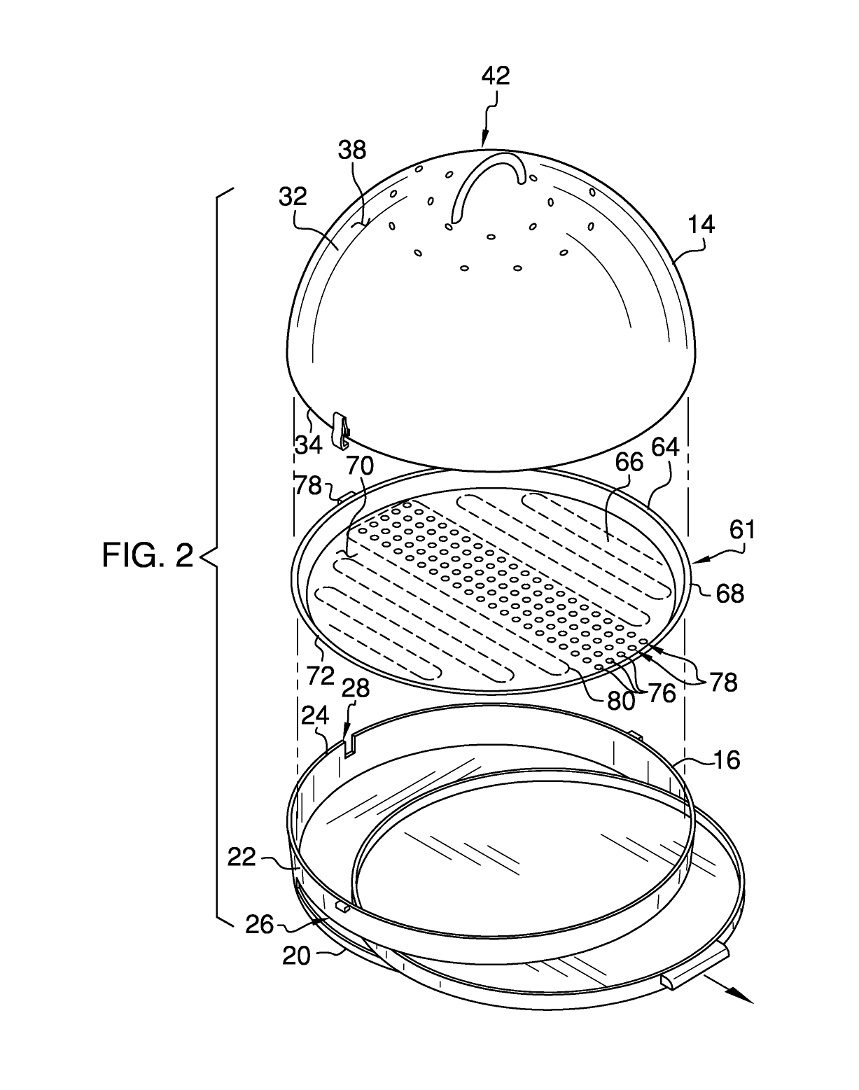

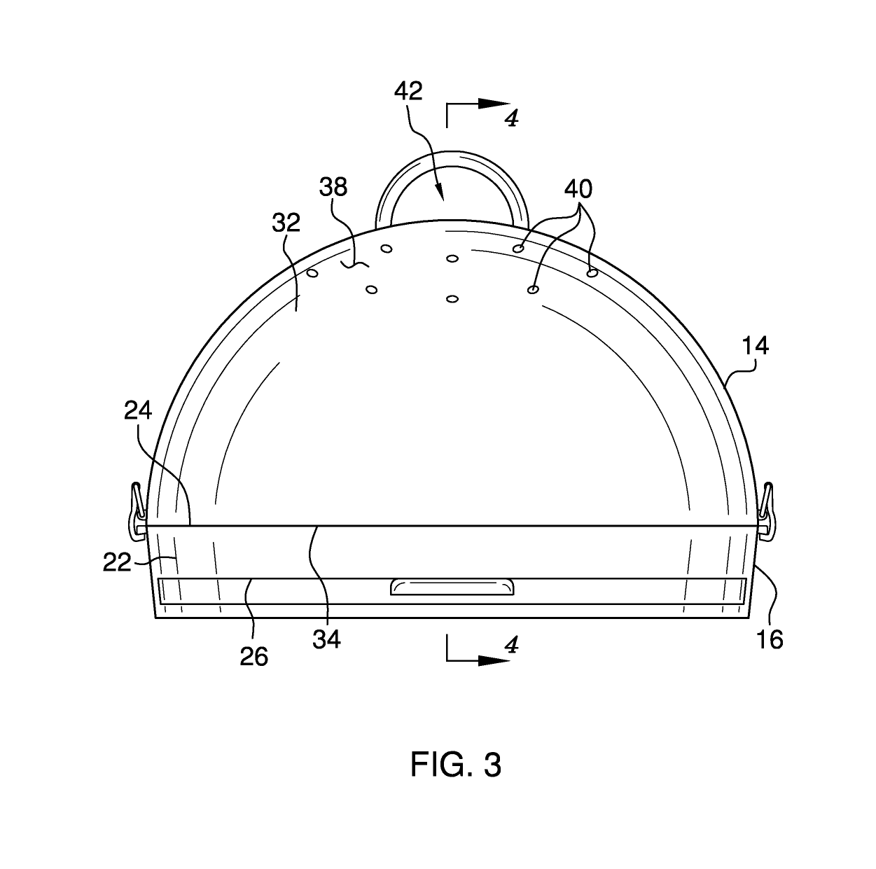

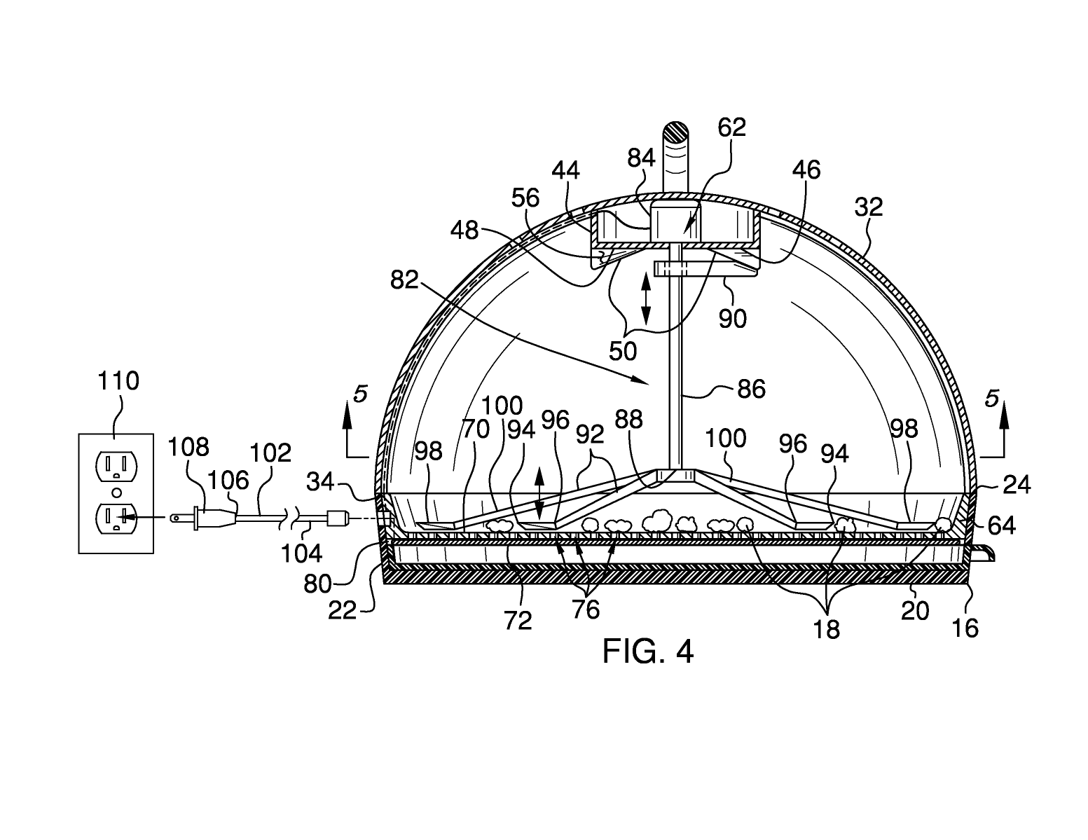

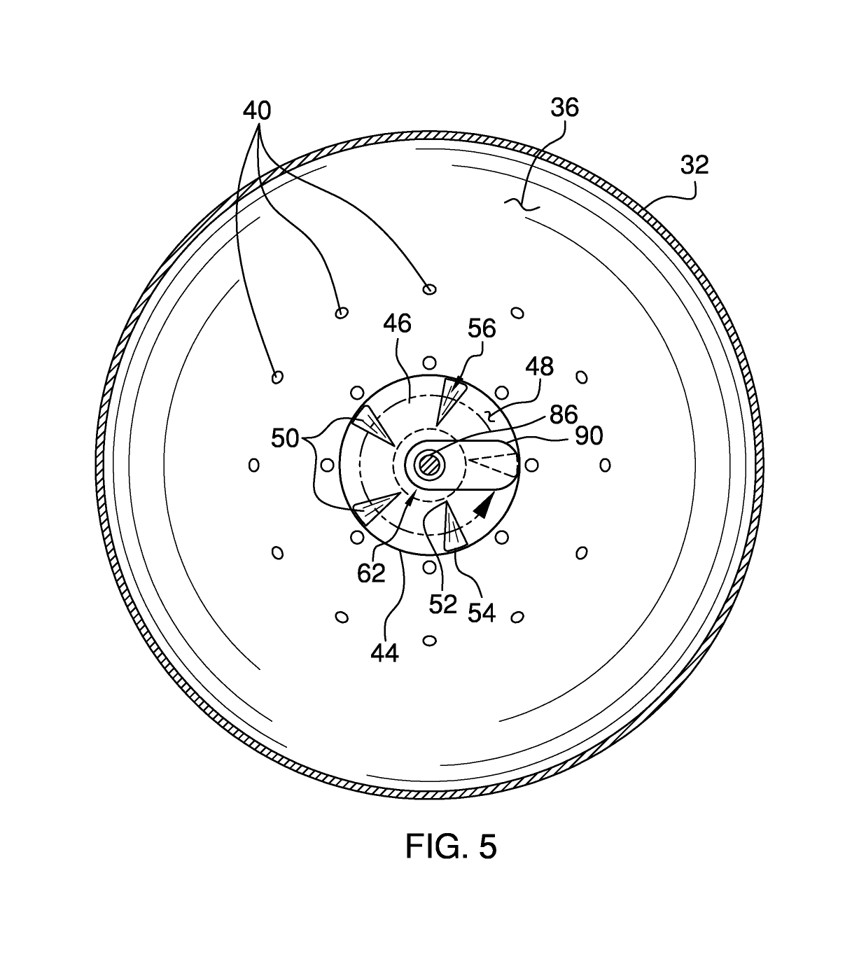

With reference now to the drawings, and in particular to FIGS. 1 through 5 thereof, a new cooking device embodying the principles and concepts of an embodiment of the disclosure and generally designated by the reference numeral 10 will be described.

As best illustrated in FIGS. 1 through 5, the cooking assembly 10 generally comprises a housing 12 that has a lid 14 and a pan 16. The pan 16 may have meat 18 positioned therein and the lid 14 is positioned to cover the pan 16. The meat 18 may comprise ground beef or the like. The pan 16 has a bottom wall 20 and a peripheral wall 22 extending upwardly from the bottom wall 20. The peripheral wall 22 has a distal edge 24 with respect to the bottom wall 20 and the peripheral wall 22 is curved such that the pan 16 has a circular shape.

The peripheral wall 22 has a slot 26 extending therethrough and the slot 26 extends substantially along the peripheral wall 22. The distal edge 24 has a groove 28 extending downwardly therein. The pan 16 includes a drawer 30 that is slidably coupled to the pan 16. The drawer 30 is slidable outwardly from the slot 26. The drawer 30 is slidable inwardly of the slot 26 such that the drawer 30 is coextensive with the bottom wall 20.

The lid 14 has an outer wall 32 and a bottom edge 34. The outer wall 32 is curved such that the lid 14 has a dome shape and the outer wall 32 has an inner surface 36 and an outer surface 38. The lid 14 is positioned on the pan 16 having the bottom edge 34 abutting the distal edge 24. The outer wall 32 has a plurality of openings 40 extending through the inner surface 36 and the outer surface 38. The openings 40 are spaced apart from each other and radiate outwardly from an apex 42 of the lid 14 such that the openings 40 may vent air.

A cup 44 is provided that has a basal wall 46. The cup 44 is coupled to the inner surface 36 of the lid 14 having the basal wall 46 being spaced from the inner surface 36. The basal wall 46 has an outermost surface 48 and the cup 44 has a plurality of lobes 50 that are each coupled to the outermost surface 48. Each of the lobes 50 has a first end 52, a second end 54, a first lateral surface 56 and a second lateral surface 60. The first lateral surface 56 slopes between the outermost surface 48 and the second lateral surface 60. The second lateral surface 60 forms a right angle with respect to the outermost surface 48. Each of the lobes 50 tapers to a point between the second end 54 and the first end 52. Each of the lobes 50 is spaced apart from each other and radiate outwardly from a center 62 of the cup 44. The first end 52 of each of the lobes 50 is directed toward the center 62 of the cup 44.

A cooking unit 61 is removably positioned within the pan 16 and the cooking unit 61 may cook the meat 18. The cooking unit 61 comprises a grill 64 that has first wall 66 and a perimeter wall 68 extending upwardly from the first wall 66. The perimeter wall 68 angles outwardly from the first wall 66 and the first wall 66 has a top surface 70 and a bottom surface 72.

The grill 64 is removably positioned within the pan 16. The perimeter wall 68 frictionally engages the peripheral wall 22 of the pan 16 such that the first wall 66 is spaced from the drawer 30. The perimeter wall 68 has a tab 74 extending outwardly therefrom. The tab 74 engages the groove 28 when the grill 64 is positioned within the pan 16. The first wall 66 has a plurality of apertures 76 extending through the top surface 70 and the bottom surface 72. Thus, the apertures 76 may allow grease to drip into the drawer 30. The apertures 76 are spaced apart from each other and arranged into a plurality of rows 78 extending across the first wall 66.

A heating coil 80 is coupled to the grill 64. The heating coil 80 is positioned between the top surface 70 and the bottom surface 72. Thus, the heating coil 80 is in thermal communication with the grill 64. The heating coil 80 generates heat when the heating coil 80 is turned on such that the grill 64 may cook the meat 18. The heating coil 80 may comprise an electrical heating coil or the like. The heating coil 80 may have an operational temperature ranging between approximately 180° Fahrenheit and 225° Fahrenheit.

A chopping unit 82 is coupled to the lid 14 such that the chopping unit 82 may chop the meat 18 in the pan 16. The chopping unit 82 comprises a motor 84 that is positioned within the cup 44. The motor 84 may comprise an electrical motor or the like. A shaft 86 is rotatably coupled to the motor 84 such that the motor 84 rotates the shaft 86 when the motor 84 is turned on.

The shaft 86 is slidable upwardly and downwardly with respect to the motor 84. The shaft 86 is biased to slide upwardly with respect to the motor 84 and the shaft 86 may be biased through magnetic attraction or the like. The shaft 86 is slidably coupled to the motor 84 through any conventional mechanical means involving a sliding shaft. The shaft 86 extends downwardly through the center 62 of the cup 44. The shaft 86 has a distal end 88 with respect to the cup 44 and the distal end 88 of the shaft 86 is substantially aligned with the bottom edge 34 of the lid 14.

An arm 90 is coupled to and extends away from the shaft 86. The arm 90 is spaced from the basal wall 46 of the cup 44. The arm 90 engages the first lateral surface 56 of each of the lobes 50 when the motor 84 rotates the shaft 86. The arm 90 urges the shaft 86 to slide downwardly with respect to the motor 84 when the arm 90 travels along the sloped first lateral surface 56 of each of the lobes 50. The shaft 86 alternately slides upwardly and downwardly with respect to the motor 84 when the motor 84 rotates the shaft 86.

A plurality of blades 92 is provided and each of the blades 92 is coupled to and extends away from the shaft 86. Each of the blades 92 is spaced apart from each other and radiate outwardly from the distal end 88 of the shaft 86. Each of the blades 92 has a distal end 94 with respect to the shaft 86. Each of the blades 92 has a bend 96 thereon to define a first portion 98 forming an angle with respect to a second portion 100 of each of the blades 92. The bend 96 is positioned closer to the distal end 94 of the blades 92 than the shaft 86.

The second portion 100 of each of the blades 92 angles downwardly between the shaft 86 and the grill 64. The first portion 98 of each of the blades 92 are oriented parallel to the top surface 70 of the grill 64. Thus, the first portion 98 of each of the blades 92 chops the meat 18 when the shaft 86 is urged downwardly with respect to the motor 84. Additionally, each of the blades 92 is rotated when the motor 84 rotates the shaft 86. Thus, each of the blades 92 stirs the meat 18 while the grill 64 cooks the meat 18 thereby facilitating the meat 18 to be browned.

A power supply 102 is coupled to the pan 18 and the power supply 102 is electrically coupled to the cooking unit 61 and the chopping unit 82. The power supply 102 comprises a power cord 104 extending outwardly from the peripheral wall 22 of the pan 16. The power cord 104 is electrically coupled to the motor 84 and the heating coil 80. The power cord 104 has a distal end 106 with respect to the peripheral wall 22. The distal end 106 of the power cord 104 has a plug 108 that is electrically coupled thereto. The plug 108 may be electrically coupled to a power source 110 and the power source 110 may comprise an electrical outlet or the like.

In use, the grill 64 is positioned within the pan 16 and the meat 18 is positioned on the grill 64. The lid 14 is positioned on the pan 16 and the power cord 104 is electrically coupled to the power source 110. The motor 84 rotates the shaft 86 and the shaft 86 rotates the blades 92. The blades 92 alternately move upwardly and downwardly with respect to the grill 64 as the motor 84 rotates the shaft 86. The blades 92 chop the meat 18 when the blades 92 move downwardly. Additionally, the blades 92 stir the meat 18 on the grill 64. The drawer 30 is removed from the pan 16 when the meat 18 is finished cooking and the drawer 30 is cleaned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cooking assembly comprising:
a housing having a lid and a pan, said pan being configured to have meat positioned therein, said lid being positioned to cover said pan;
a cooking unit being removably positioned within said pan wherein said cooking unit is configured to cook the meat; and
a chopping unit being coupled to said lid wherein said chopping unit is configured to chop the meat in said pan.

2. The assembly according to claim 1, wherein said pan has a bottom wall and a peripheral wall extending upwardly from said bottom wall, said peripheral wall having a distal edge with respect to said bottom wall, said peripheral wall being curved such that said pan has a circular shape, said peripheral wall having a slot extending therethrough, said slot extending substantially along said peripheral wall, said distal edge having a groove extending downwardly therein.

3. The assembly according to claim 2, wherein said pan includes a drawer being slidably coupled to said pan, said drawer being slidable outwardly from said slot, said drawer being slidable inwardly of said slot such that said drawer is coextensive with said bottom wall.

4. The assembly according to claim 1, wherein:
said pan has a distal edge; and
said lid has an outer wall and a bottom edge, said outer wall being curved such that said lid has a dome shape, said outer wall having an inner surface and an outer surface, lid being positioned on said pan having said bottom edge abutting said distal edge, said outer wall having a plurality of openings extending through said inner surface and said outer surface, said openings being spaced apart from each other and radiating outwardly from an apex of said lid wherein said openings are configured to vent air.

5. The assembly according to claim 4, further comprising a cup having a basal wall, said cup being coupled to said inner surface of said lid having said basal wall being spaced from said inner surface, said basal wall having an outermost surface.

6. The assembly according to claim 5, wherein said cup has a plurality of lobes coupled to said outermost surface, each of said lobes having a first end, a second end, a first lateral surface and a second lateral surface, said first lateral surface sloping between said outermost surface and said second lateral surface, each of said lobes tapering to a point between said second end and said first end, each of said lobes being spaced apart from each other and radiating outwardly from a center of said cup having said first end of each of said lobes being directed toward said center of said cup.

7. The assembly according to claim 1, wherein:
said pan has a peripheral wall and a groove; and
said cooking unit comprises a grill having first wall and a perimeter wall extending upwardly from said first wall, said perimeter wall angling outwardly from said first wall, said first wall having a top surface and a bottom surface, said grill being removably positioned within said pan, said perimeter wall frictionally engaging said peripheral wall of said pan such that said first wall is spaced from said drawer, said perimeter wall having a tab extending outwardly therefrom, said tab engaging said groove when said grill is positioned within said pan.

8. The assembly according to claim 7, wherein said first wall has a plurality of apertures extending through said top surface and said bottom surface wherein said apertures are configured to allow grease to drip into a drawer, said apertures being spaced apart from each other and arranged into a plurality of rows extending across said first wall.

9. The assembly according to claim 7, further comprising a heating coil being coupled to said grill, said heating coil being positioned between said top surface and said bottom surface such that said heating coil is in thermal communication with said grill, said heating coil generating heat when said heating coil is turned on wherein said grill is configured to cook the meat.

10. The assembly according to claim 1, wherein said chopping unit comprises:
a motor being positioned within said cup; and
a shaft being rotatably coupled to said motor such that said motor rotates said shaft when said motor is turned on, said shaft being slidable upwardly and downwardly with respect to said motor, said shaft being biased to slide upwardly with respect to said motor, said shaft extending downwardly through said center of said cup, said shaft having a distal end with respect to said cup, said distal end being substantially aligned with said bottom edge of said lid.

11. The assembly according to claim 10, further comprising:
a cup having a basal wall;
a plurality of lobes being coupled to said basal wall, each of said lobes having a first lateral surface; and
an arm being coupled to and extending away from said shaft, said arm being spaced from said basal wall of said cup, said arm engaging said first lateral surface of each of said lobes when said motor rotates said shaft, said arm urging said shaft to slide downwardly with respect to said motor when said arm travels along said first lateral surface of each of said lobes, said shaft alternately sliding upwardly and downwardly with respect to said motor when said motor rotates said shaft.

12. The assembly according to claim 10, further comprising:
a grill; and
a plurality of blades, each of said blades being coupled to and extending away from said shaft, each of said blades being spaced apart from each other and radiating outwardly from said distal end of said shaft, each of said blades having a distal end with respect to said shaft, each of said blades having a bend thereon to define a first portion forming an angle with respect to a second portion of each of said blades, said bend being positioned closer to said distal end of said blades than said shaft, said second portion of each of said blades angling downwardly toward said grill.

13. The assembly according to claim 12, wherein said first portion of each of said blades is oriented parallel to said top surface of said grill wherein said first portion of each of said blades is configured to chop the meat when said shaft is urged downwardly with respect to said motor, each of said blades being rotated when said motor rotates said shaft wherein each of said blades is configured to stir the meat while said grill cooks the meat thereby facilitating the meat to be browned.

14. The assembly according to claim 1, further comprising:
said pan having a peripheral wall;
a motor;
a heating coil; and
a power supply being coupled to said pan, said power supply being electrically coupled to said cooking unit and said chopping unit, said power supply comprising a power cord extending outwardly from said peripheral wall of said pan, said power cord being electrically coupled to said motor and said heating coil, said power cord having a distal end with respect to said peripheral wall, said distal end of said power cord having a plug being electrically coupled thereto, said plug being configured to be electrically coupled to a power source.

15. A cooking assembly comprising:
a housing having a lid and a pan, said pan being configured to have meat positioned therein, said lid being positioned to cover said pan, said pan having a bottom wall and a peripheral wall extending upwardly from said bottom wall, said peripheral wall having a distal edge with respect to said bottom wall, said peripheral wall being curved such that said pan has a circular shape, said peripheral wall having a slot extending therethrough, said slot extending substantially along said peripheral wall, said distal edge having a groove extending downwardly therein, said pan including a drawer being slidably coupled to said pan, said drawer being slidable outwardly from said slot, said drawer being slidable inwardly of said slot such that said drawer is coextensive with said bottom wall, said lid having an outer wall and a bottom edge, said outer wall being curved such that said lid has a dome shape, said outer wall having an inner surface and an outer surface, lid being positioned on said pan having said bottom edge abutting said distal edge, said outer wall having a plurality of openings extending through said inner surface and said outer surface, said openings being spaced apart from each other and radiating outwardly from an apex of said lid wherein said openings are configured to vent air;
a cup having a basal wall, said cup being coupled to said inner surface of said lid having said basal wall being spaced from said inner surface, said basal wall having an outermost surface, said cup having a plurality of lobes coupled to said outermost surface, each of said lobes having a first end, a second end, a first lateral surface and a second lateral surface, said first lateral surface sloping between said outermost surface and said second lateral surface, each of said lobes tapering to a point between said second end and said first end, each of said lobes being spaced apart from each other and radiating outwardly from a center of said cup having said first end of each of said lobes being directed toward said center of said cup;
a cooking unit being removably positioned within said pan wherein said cooking unit is configured to cook the meat, said cooking unit comprising:
a grill having first wall and a perimeter wall extending upwardly from said first wall, said perimeter wall angling outwardly from said first wall, said first wall having a top surface and a bottom surface, said grill being removably positioned within said pan, said perimeter wall frictionally engaging said peripheral wall of said pan such that said first wall is spaced from said drawer, said perimeter wall having a tab extending outwardly therefrom, said tab engaging said groove when said grill is positioned within said pan, said first wall having a plurality of apertures extending through said top surface and said bottom surface wherein said apertures are configured to allow grease to drip into said drawer, said apertures being spaced apart from each other and arranged into a plurality of rows extending across said first wall, and
a heating coil being coupled to said grill, said heating coil being positioned between said top surface and said bottom surface such that said heating coil is in thermal communication with said grill, said heating coil generating heat when said heating coil is turned on wherein said grill is configured to cook the meat;
a chopping unit being coupled to said lid wherein said chopping unit is configured to chop the meat in said pan, said chopping unit comprising:
a motor being positioned within said cup,
a shaft being rotatably coupled to said motor such that said motor rotates said shaft when said motor is turned on, said shaft being slidable upwardly and downwardly with respect to said motor, said shaft being biased to slide upwardly with respect to said motor, said shaft extending downwardly through said center of said cup, said shaft having a distal end with respect to said cup, said distal end being substantially aligned with said bottom edge of said lid,
an arm being coupled to and extending away from said shaft, said arm being spaced from said basal wall of said cup, said arm engaging said first lateral surface of each of said lobes when said motor rotates said shaft, said arm urging said shaft to slide downwardly with respect to said motor when said arm travels along said first lateral surface of each of said lobes, said shaft alternately sliding upwardly and downwardly with respect to said motor when said motor rotates said shaft, and
a plurality of blades, each of said blades being coupled to and extending away from said shaft, each of said blades being spaced apart from each other and radiating outwardly from said distal end of said shaft, each of said blades having a distal end with respect to said shaft, each of said blades having a bend thereon to define a first portion forming an angle with respect to a second portion of each of said blades, said bend being positioned closer to said distal end of said blades than said shaft, said second portion of each of said blades angling downwardly toward said grill, said first portion of each of said blades being oriented parallel to said top surface of said grill wherein said first portion of each of said blades is configured to chop the meat when said shaft is urged downwardly with respect to said motor, each of said blades being rotated when said motor rotates said shaft wherein each of said blades is configured to stir the meat while said grill cooks the meat thereby facilitating the meat to be browned; and
a power supply being coupled to said pan, said power supply being electrically coupled to said cooking unit and said chopping unit, said power supply comprising a power cord extending outwardly from said peripheral wall of said pan, said power cord being electrically coupled to said motor and said heating coil, said power cord having a distal end with respect to said peripheral wall, said distal end of said power cord having a plug being electrically coupled thereto, said plug being configured to be electrically coupled to a power source.
